(19) United States
(12) Patent Application Publication
(10) Pub. No.: US 2004/0167774 A1
(43) Pub. Date: Aug. 26, 2004

(54) Audio-based method, system, and apparatus for measurement of voice quality

(75) Inventor: Rahul Shrivastav, Gainesville, FL (US)

Correspondence Address: Gregory A. Nelson, Akerman Senterfitt, P.O. Box 3188, West Palm Beach, FL, 33402-3188, US

(73) Assignees: University of Florida, Gainesville, FL; Indiana University, Indianapolis, IN

(21) Appl. No.: 10/722,285

(22) Filed: Nov. 25, 2003

Related U.S. Application Data
(60) Provisional application No. 60/429,830, filed on Nov. 27, 2002.

(51) Int. Cl. G10L 11/04

(52) U.S. Cl. 704/207

(57) ABSTRACT

A method of diagnosing voices can include processing a test voice signal using an auditory model, determining at least one voice quality attribute from the test voice signal, and comparing the at least one voice quality attribute from the test voice signal with at least one baseline voice quality attribute. The method also can include determining a measure of voice quality of the test voice signal based upon the comparing step.

### CROSS-REFERENCE TO RELATED APPLICATIONS

This application claims the benefit of U.S. Provisional Application No. 60/429,830, filed in the United States Patent and Trademark Office on Nov. 27, 2002, the entirety of which is incorporated herein by reference.

### BACKGROUND

1. Field of the Invention

The invention relates to the measurement of voice quality.

2. Description of the Related Art

Voice quality can be defined as those aspects of a speech signal that serve to perceptually distinguish two voices producing the same utterance at the same pitch and loudness. Description of voice quality and quantification of the type and degree of deviation of voice quality from normal are important components of voice evaluation. These components are essential to better understand patients' complaints and to help in the management of voice disorders.

The perceived voice quality results from the acoustic signal generated during the process of speech production. This process involves the generation of a sound by the vibration of the vocal folds and/or turbulence noise created by impeding the airflow from the lungs within the vocal tract. The sound thus generated is modified as it passes through the vocal tract (oral and nasal cavities). The perceived voice quality, therefore, varies within and across speakers because of differences in the sound generated by the vocal folds, the turbulence noise, and the modifying effects of the vocal tract. Voice quality also varies across different speakers. These variations serve to reveal the speaker's identity, age, gender, and the like.

Voice quality variances within the same speaker can result from disease or vocal pathologies, voluntary changes in the voice production, for example when one imitates another person, the emotional content of speech, and the like. A voice can be said to be disordered when a person's voice quality, pitch, or loudness differ from that of another person's voice of similar age, sex, cultural background, and geographic location. For example, a voice can be said to be breathy, rough, hoarse, or the like.

Generally, breathiness in a voice pertains to the audible escape of air resulting in a thin and weak phonation. Breathiness can result from incomplete adduction of the vocal folds, leading to an insufficient glottal closure. Roughness results from pathologies that affect the vibratory behavior of the vocal folds and is the perception of irregularity in vocal fold vibration. Irregular vocal fold vibrations lead to the presence of a low frequency noise component in the voice described as roughness. Hoarseness is often described as being a combination of roughness and breathiness. Thus, hoarseness can be characterized by irregular vocal fold vibrations along with additive noise. These attributes of the vocal acoustic signal are further modified by the resonances associated with the vocal tract.

One method of measuring voice quality is through the use of subjective ratings. In using this method, the clinician listens to the voice in question and assigns the voice a numerical and/or categorical rating. This rating reflects the listener's subjective impression of voice quality. Many different protocols, scales, and procedures, such as the Buffalo Voice Profile, as disclosed in D. K. Wilson, “Voice problems of children”, Williams & Wilkins (1987), and the GRBAS scale, as developed by the Japan Logopedic and Phoniatric Society, have been proposed to obtain subjective ratings of voice quality.

Subjective methods of measuring voice quality, however, have disadvantages. Although individual listeners tend to be consistent in making voice quality judgments, subjective ratings by multiple listeners often are not consistent from one listener to the next. This leads to questions about the validity of voice quality measures. Additionally, subjective ratings have been shown to vary with the listener's professional background, training, experience, and linguistic background.

Another method of measuring voice quality is to make objective measures of vocal physiology or acoustics that may reflect a change in voice quality. Because voice quality is the end result of certain physiological events that take place in the production of the acoustic signal, measures from either of these two signals may be associated with vocal changes. Examples of objective measures of voice quality can include, but are not limited to, measures of aspiration noise, frequency and intensity perturbation, and signal-to-noise (SNR) ratios. Still, research studies directed at validating the use of objective measures in describing voice quality have been unable to determine measures that show a consistent correlation with subjective ratings.

Objective techniques for measuring voice quality do not account for the non-linear behavior of the human auditory system. That is, objective techniques used to describe voice quality represent the physical signal as captured by a microphone and the recording system, but ignore the fact that the transformations occurring in the peripheral auditory system are an inherent part of the auditory-perceptual process. Voice quality must be defined in terms of the perceptual consequence of the acoustic signal. The measurement of voice quality requires an understanding of the relationship between the acoustic signal and the psychological perception by the listener as a consequence of the human auditory system.

Accordingly, despite significant advances made in our knowledge of vocal physiology in people with normal and disordered voices, researchers and clinicians lack a universally accepted method to describe and quantify voice quality.

### SUMMARY OF THE INVENTION

The present invention provides a method, system, and apparatus for diagnosing the quality of a voice. Rather than attempt to use subjective analysis of a voice signal, the present invention processes the voice signal using a model of the human auditory system. The model accounts for the psychological perception of a listener. The resulting voice signal then can be analyzed using objective criteria to determine a measure of quality of the voice under test.

One aspect of the present invention can include a method of diagnosing voices. The method can include processing a test voice signal using an auditory model, determining at least one voice quality attribute from the test voice signal, and comparing the at least one voice quality attribute from the test voice signal with at least one baseline voice quality attribute. The method also can include determining a measure of voice quality of the test voice signal based upon the comparing step. The method further can include determining a degree of the measure of voice quality.

In another embodiment of the present invention, the measure of voice quality can be roughness, hoarseness, strain or other voice quality characteristics that are commonly encountered across different speakers. Accordingly, the voice quality attributes of the test voice signal can include parameters such as changes in pitch over time, changes in loudness over time, or other temporal and/or spectral characteristics of the vocal acoustic signal. The voice quality attribute of the test voice signal also can include a measure of partial loudness which accounts for the phenomenon of auditory masking.

In another embodiment, the voice quality can be breathiness. In that case, the voice quality attributes can include a measure of low frequency periodic energy, a measure of high frequency aperiodic energy, and/or a measure of partial loudness of a periodic signal portion of the test voice signal. The voice quality attributes of the test voice signal further can include a measure of noise in the test voice signal and a measure of partial loudness of the test voice signal.

Another aspect of the present invention can include a system having means for performing the methods and techniques disclosed herein as well as a machine readable storage for causing a machine to perform the methods and techniques disclosed herein.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for determining a measure of voice quality in accordance with one embodiment of the present invention.

FIG. 2 is a flow chart illustrating a method of determining a measure of voice quality in accordance with one embodiment of the present invention.

### DETAILED DESCRIPTION OF THE INVENTION

The present invention provides an automated solution for diagnosing the quality of a voice under test. The present invention processes a voice signal using a model of the human auditory system. The model accounts for psychological perception of a listener such as a clinician. Accordingly, the resulting voice signal can be analyzed using objective criteria to determine a measure of quality of the voice under test. More particularly, the present invention can determine a measure of quality of the voice signal with respect to breathiness, roughness, and/or hoarseness.

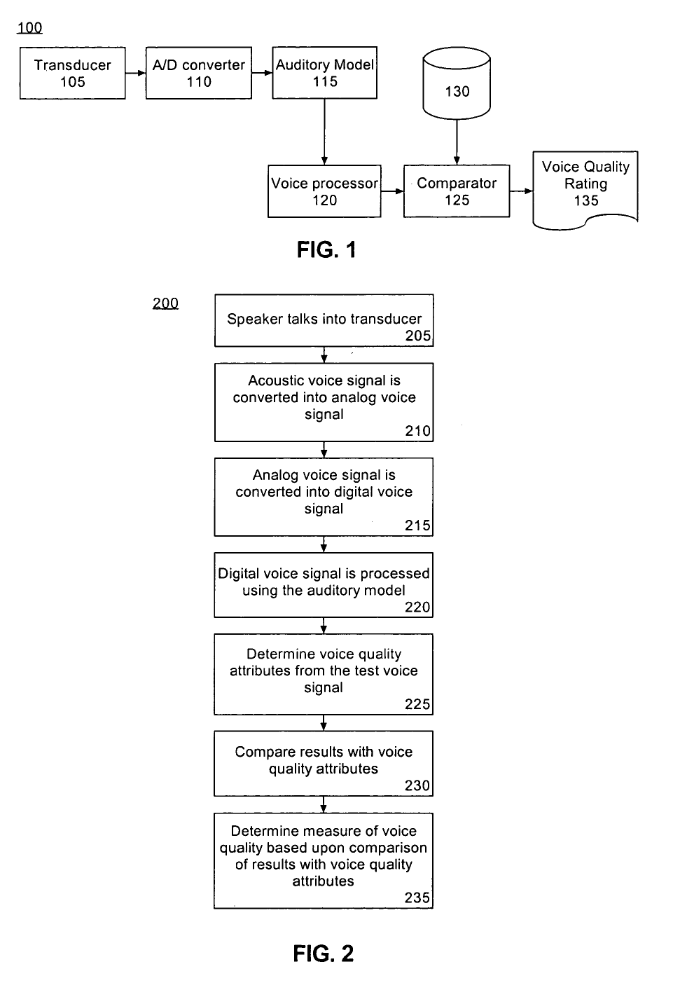

FIG. 1 is a schematic diagram illustrating a system 100 for determining a measure of voice quality in accordance with one embodiment of the present invention. As shown, the system 100 can include a transducer 105, an analog-to-digital (A/D) converter 110, an auditory model 115, a voice processor 120, a comparator 125, and baseline voice quality attributes 130. The transducer 105 can be any of a variety of transducive elements capable of detecting an acoustic sound source and converting the sound wave to an analog signal. The A/D converter 110 can convert the received analog signal to a digital representation of the signal.

The auditory model 115 can be embodied as a computer program executing within a suitable information processing system. The auditory model 115 is an implementation of the transfer function of the human auditory system. As such, the auditory model 115 processes a received digitized voice signal and accounts for the psychological perception of a listener. The auditory model 115 can simulate the process involved in the transduction of acoustic stimuli into neural activity by the peripheral auditory system. Because some stages of this transduction process involve non-linear computations, the output of the auditory model 115 is considerably different from the input. Such internal representations of acoustic stimuli better characterize perceptual characteristics than the typical mathematical representations of the acoustic stimuli in the time or frequency domain.

According to one embodiment of the present invention, the auditory model 115 can be the transfer function corresponding to the outer and middle portions of the human ear, the excitation pattern elicited on the basilar membrane within the cochlea, and the transduction of this excitation pattern into neural activity in the fibers of the auditory nerve. For example, such an auditory model has been proposed by B. C. J. Moore and B. R. Glasberg et al., “A model for the prediction of thresholds, loudness and partial loudness”, Journal of Audio Engineering Society, 45(3): 224-239 (1997); and B. R. Glasberg and B. C. Moore, “Growth-of-masking functions for several types of maskers”, Journal of the Acoustical Society of America, 96(1): 134-44 (1994).

In any case, it should be appreciated that the present invention is not limited to the use of a particular auditory model 115. Rather, any of a variety of auditory models can be used such as those proposed by R. D. Patterson, M. H. Allerhand et al., “Time-domain modeling of peripheral auditory processing: A modular architecture and software platform”, Journal of the Acoustical Society of America, 98(4): 1890-1894 (1995); B. C. Moore, et al., “A model for the prediction of thresholds, loudness and partial loudness”; and J. Tchorz and B. Kollmeier, “A model of auditory perception as front end for automatic speech recognition”, Journal of the Acoustical Society of America, 106(4 Pt 1): 2040-50 (1999).

The voice processor 120 can be embodied as a computer program executing within a suitable information processing system. As such, the voice processor 120 can receive the processed voice signal from the auditory model 115 and extract or derive one or more voice quality attributes. In particular, with respect to breathiness, the voice processor 120 can determine voice quality attributes including, but not limited to, low frequency periodic energy in the test voice signal, high frequency aperiodic energy in the test voice signal, partial loudness of a periodic signal portion of the test voice signal, as well as the combination of noise in the test voice signal and partial loudness of the test voice signal. These voice quality attributes can be evaluated over a period of time. For example, the test voice signal can be averaged over a period of time of approximately 0.4-0.6 seconds. The present invention, however, should not be limited to a particular time frame for averaging the test voice signal.

With respect to roughness and/or hoarseness, the voice processor 120 can determine voice quality attributes from the test voice signal such as changes in voice pitch over time, changes in loudness over time, and/or a measure of partial loudness. These changes can be evaluated by averaging the test voice signal over a shorter time period, for example a time period of approximately 5-10 milliseconds.

The voice processor 120 also can extract other features from a received voice signal. For example, the voice processor 120 can identify factors associated with changes in vocal fold vibration such as fundamental frequency, intensity, frequency and intensity perturbation, noise, spectral slope, and the like. The voice processor 120 also can identify factors associated with changes in vocal tract such as formant frequencies, formant bandwidths, nasality, formant frequency transitions, spectral peaks and valleys, and the like.

Notably, the auditory model 115 transforms the vocal signal into a form that reflects how these are encoded by the human auditory system. This results in appropriate non-linear scaling of the above mentioned parameters. Application of the auditory model 115 also can result in new parameters of pitch, loudness, partial loudness, etc. Changes in these parameters can result in a better correlation between the subjective ratings and objective measures of voice quality, thereby providing a means to automatically classify and quantify changes in voice quality such as breathy, rough and strain.

The baseline voice quality attributes 130, stored in a suitable data store, can include various attributes relating to one or more baseline voice signal(s). The voice quality attributes 130 provide a measure for determining whether a test voice signal is breathy, rough, and/or hoarse with respect to one or more baseline voice signal(s). For example, with respect to breathiness, the baseline voice quality attributes 130 can include, but are not limited to, low frequency periodic energy in the voice signal, high frequency aperiodic energy in the voice signal, partial loudness of a periodic signal portion of the voice signal, as well as the combination of noise in the voice signal and partial loudness of the voice signal.

With respect to roughness and/or hoarseness, the baseline voice quality attributes 130 can include changes in voice pitch over time, changes in loudness over time, and a measure of partial loudness. Still, the voice quality attributes 130 can include parameters relating to vocal fold vibration and the vocal tract. For example, such voice quality attributes can include, but are not limited to, fundamental frequency, intensity, frequency and intensity perturbation, noise, spectral slope, formant frequencies, formant bandwidths, nasality, formant frequency transitions, spectral peaks and valleys, and the like.

The baseline voice quality attributes 130 can be derived from a representative or baseline voice signal, or more than one baseline voice signal. For example, the baseline voice quality attributes 130 can be extracted from a sample or “normal” voice signal or can be an average of like voice quality attributes from more than one voice signal. In any case, the baseline voice quality attributes 130 serve as a baseline against which the voice signal attributes of the test voice signal can be compared.

For example, through empirical studies, a set of parameter values can be defined that are commonly seen in the population. Such normative values can be used to develop a baseline measure, such as that for comparing a “normal” voice to a “disordered” voice. Changes in these values can be used to track the success of treatment for voice disorders, such as before and after surgery and/or voice therapy. Changes in these values may also be used to monitor changes related to the speaker's age, emotion, etc. Changes in these values may also find utility in determining the success of speech recording, processing or transmission.

The comparator 125 compares the voice quality attributes from the test voice signal with the baseline voice quality attributes 130. Through the comparison, the comparator 125 can determine a voice quality rating 135 for the test voice signal. That is, if one or more of the voice quality attributes is determined to exceed a corresponding baseline voice quality attribute, the test voice signal can be determined to be breathy, or at least more breathy than the baseline voice signal(s) used to determine the baseline voice quality attributes. In another embodiment, if the test voice changes with respect to pitch and/or loudness over time, more so than the corresponding baseline voice quality attributes, the test voice can be said to be rough and/or hoarse, or at least more rough and/or hoarse than the baseline voice(s) used to determine the baseline voice quality attributes. As noted, partial loudness also can be used to evaluate hoarseness, and therefore, can be compared along with changes in pitch and/or loudness over time.

The system 100 can be implemented in any of a variety of configurations. In one embodiment, the transducer 105, the A/D converter 110, the auditory model 115, the voice processor 120, the comparator 125, and the voice quality attributes 130 can be embodied as one or more information processing systems or standalone components. For example, while a computer system having a suitable soundcard and microphone can be used, it should be appreciated that the present invention also can be implemented as one or more dedicated processing machines. In one embodiment, the auditory model 115, the voice processor 120, and the comparator 125 each can be implemented as a computer program, for instance using Matlab or another signal processing application.

FIG. 2 is a flow chart illustrating a method 200 of determining a measure of voice quality in accordance with one embodiment of the present invention. The method 200 can be implemented using the system of FIG. 1. Accordingly, the method 200 can begin instep 205, where a speaker talks into a microphone. In step 210, the transducer detects and converts the acoustic voice signal into an analog voice signal.

In step 215, the analog voice signal can be converted to a digital voice signal by the A/D converter. The analog voice signal can be converted to a digital voice signal using a suitable sampling rate so as to preserve necessary audio quality of the voice signal for further processing. In step 220, the digital voice signal is provided to and processed using the auditory model.

In step 225, the test voice signal, after processing using the auditory model, can be processed by the voice processor to determine one or more voice quality attributes that can be compared with the baseline voice quality attributes. For example, the voice processor can determine low frequency periodic energy and high frequency aperiodic energy in the test voice signal. The voice processor also can determine partial loudness of a periodic signal portion of the test voice signal as well as the combination of noise in the test voice signal and partial loudness of the test voice signal. The voice processor also can determine changes in voice pitch over time, changes in loudness over time, and a measure of partial loudness with respect to the test voice signal.

The comparator can compare the voice quality attributes determined from the test voice signal with the baseline voice quality attributes in step 230. As noted, the voice quality attributes can be determined from a baseline voice signal. The baseline voice signal can be a particular voice signal determined, through an empirical study, to have average qualities with respect to breathiness, roughness, and/or hoarseness, or can be an average of voice quality attributes from more than one baseline voice signal.

In step 235, one or more measures of voice quality can be determined based upon the comparison of the voice quality attributes derived from the test voice signal with the baseline voice quality attributes. That is, each voice quality attribute determined from the test voice signal can be compared with the corresponding baseline voice quality attribute. In one embodiment, the test voice signal can be determined to be more or less breathy, rough, and/or hoarse in comparison with the baseline voice(s) used to determine the baseline voice quality attributes. In another embodiment, a degree of breathiness, roughness, and/or hoarseness can be determined based upon the amount each voice quality attribute of the test voice signal exceeds each baseline voice quality attribute, or an amount determined from a summation of how much each baseline voice quality attribute exceeds or does not exceed the corresponding voice quality attribute of the test voice signal.

It should be appreciated by those skilled in the art, however, that any of a variety of statistical processing and/or scaling techniques can be used for determining a degree of breathiness, roughness, and/or hoarseness for a test voice signal. That is, such techniques can be applied after the comparison step to determine such a degree of a measure of voice quality. The present invention can provide an absolute measure of voice quality. By determining those aspects of the speech signal that are. relevant to the perception of quality and by establishing the relationships between the various parameters, the present invention provides a solution for characterizing voice quality.

As noted, the present invention can be used in the context of speech recording, processing or transmission. For example, the present invention can be used to judge the effect of a particular transmission channel or transmission technology on particular voices. That is, by determining the quality of a voice after transmission through a given communications channel through a comparison of the metrics discussed herein, one can determine whether the transmission channel exacerbates an existing vocal condition, improves an existing vocal condition, or introduces features of a vocal condition. Such a methodology also can be applied to the evaluation of communications devices such as telephones, mobile phones, radios, and the like.

The present invention can be realized in hardware, software, or a combination of hardware and software. Aspects of the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

Aspects of the present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of diagnosing voices comprising:
processing a test voice signal using an auditory model;
determining at least one voice quality attribute from the test voice signal;
comparing the at least one voice quality attribute from the test voice signal with at least one baseline voice quality attribute; and
based upon said comparing step, determining at least one measure of voice quality of the test voice signal.

2. The method of claim 1, further comprising determining a degree of the measure of voice quality.

3. The method of claim 1, wherein the measure of voice quality is at least one of roughness and hoarseness.

4. The method of claim 3, wherein the voice quality attributes of the test voice signal include changes in pitch over time and changes in loudness over time.

5. The method of claim 4, wherein the voice quality attribute of the test voice signal includes a measure of partial loudness.

6. The method of claim 1, wherein the measure of voice quality is breathiness.

7. The method of claim 6, wherein the voice quality attribute of the test voice signal includes a measure of low frequency periodic energy.

8. The method of claim 6, wherein the voice quality attribute of the test voice signal includes a measure of high frequency aperiodic energy.

9. The method of claim 6, wherein the voice quality attribute of the test voice signal includes a measure of partial loudness of a periodic signal portion of the test voice signal.

10. The method of claim 6, wherein the voice quality attributes of the test voice signal include a measure of noise in the test voice signal and a measure of partial loudness of the test voice signal.

11. A system for diagnosing voices comprising:
means for processing a test voice signal using an auditory model;
means for determining at least one voice quality attribute from the test voice signal;
means for comparing the at least one voice quality attribute from the test voice signal with at least one baseline voice quality attribute; and
means for determining at least one measure of voice quality of the test voice signal based upon said means for comparing.

12. The system of claim 11, further comprising means for determining the degree of the measure of voice quality.

13. The system of claim 11, wherein the measure of voice quality is at least one of roughness and hoarseness.

14. The system of claim 13, wherein the voice quality attributes of the test voice signal include changes in pitch over time and changes in loudness over time.

15. The system of claim 14, wherein the voice quality attribute of the test voice signal includes a measure of partial loudness.

16. The system of claim 11, wherein the measure of voice quality is breathiness.

17. The system of claim 16, wherein the voice quality attribute of the test voice signal includes a measure of low frequency periodic energy.

18. The system of claim 16, wherein the voice quality attribute of the test voice signal includes a measure of high frequency aperiodic energy.

19. The system of claim 16, wherein the voice quality attribute of the test voice signal includes a measure of partial loudness of a periodic signal portion of the test voice signal.

20. The system of claim 16, wherein the voice quality attributes of the test voice signal include a measure of noise in the test voice signal and a measure of partial loudness of the test voice signal.

21. A machine readable storage, having stored thereon a computer program having a plurality of code sections executable by a machine for causing the machine to perform the steps of:
processing a test voice signal using an auditory model;
determining at least one voice quality attribute from the test voice signal;
comparing the at least one voice quality attribute from the test voice signal with at least one baseline voice quality attribute; and
based upon said comparing step, determining at least one measure of voice quality of the test voice signal.

22. The machine readable storage of claim 21, further comprising determining the degree of the measure of voice quality.

23. The machine readable storage of claim 21, wherein the measure of voice quality is at least one of roughness and hoarseness.

24. The machine readable storage of claim 23, wherein the voice quality attributes of the test voice signal include changes in pitch over time and changes in loudness over time.

25. The machine readable storage of claim 24, wherein the voice quality attribute of the test voice signal includes a measure of partial loudness.

26. The machine readable storage of claim 21, wherein the measure of voice quality is breathiness.

27. The machine readable storage of claim 26, wherein the voice quality attribute of the test signal includes a measure of low frequency periodic energy.

28. The machine readable storage of claim 26, wherein the voice quality attribute of the test voice signal includes a measure of high frequency aperiodic energy.

29. The machine readable storage of claim 26, wherein the voice quality attribute of the test voice signal includes a measure of partial loudness of a periodic signal portion of the test voice signal.

30. The machine readable storage of claim 26, wherein the voice quality attributes of the test voice signal include a measure of noise in the test voice signal and a measure of partial loudness of the test voice signal.
